(19) United States
(12) Patent Application Publication
(10) Pub. No.: US 2025/0263120 A1
(43) Pub. Date: Aug. 21, 2025

(54) Method and Control Device for Operating a Steering Mechanism of a Vehicle

(71) Applicant: Robert Bosch GmbH, Stuttgart (DE)

(72) Inventors: Christian Riese, Stuttgart (DE); Matthias Ehrmann, Neuhausen (DE); Thomas Kurz, Roemerberg (DE); Tobias Ritz, Leonberg (DE)

(21) Appl. No.: 19/041,175

(22) Filed: Jan. 30, 2025

(30) Foreign Application Priority Data
Feb. 15, 2024 (DE) 10 2024 201 391.9

(51) Int. Cl. B62D 6/04

(52) U.S. Cl. CPC B62D 6/04

(57) ABSTRACT

A method is for operating a steering mechanism of a vehicle. In response to detecting a squealing situation, the method includes articulating at least two stecrable wheels of the vehicle according to Ackermann.

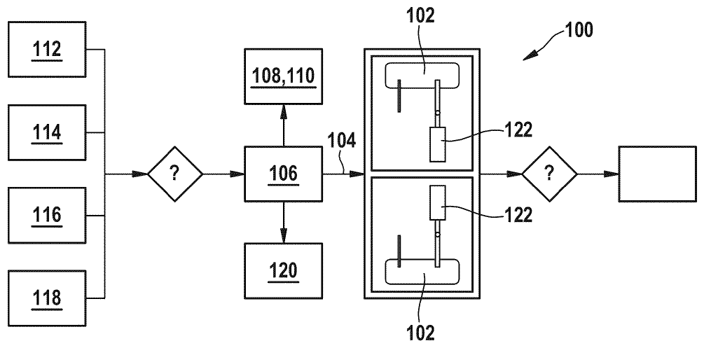

This application claims priority under 35 U.S.C. § 119 to patent application no. DE 10 2024 201 391.9, filed on Feb. 15, 2024 in Germany, the disclosure of which is incorporated herein by reference in its entirety.

The disclosure relates to a method for operating a steering mechanism of a vehicle, a corresponding control device, and a corresponding computer program product.

### BACKGROUND

A vehicle can have a steering kinematics that allows a compromise between different driving situations. This steering kinematics can deviate from steering angles according to Ackermann to improve the driving dynamics of the vehicle. This can result in a large slip, particularly on slippery surfaces and at large steering angles, which can lead to squealing noises.

### SUMMARY

With this in mind, the approach presented here involves a method for operating a steering mechanism of a vehicle, a corresponding control device, and a corresponding computer program product in accordance with the independent claims. Advantageous further developments and improvements of the approach presented here will emerge from the description and are described in the dependent claims.

In the approach presented here, the steered wheels are articulated according to Ackermann's steering angles in situations where squealing noises are possible. This ensures that the vehicle's wheels roll in an ideal slip-free manner around an instantaneous center of rotation of the vehicle. Since there is little or no slip, squealing is prevented. If no squealing situation is detected or a non-squealing situation is detected, the wheels are preferably articulated with different steering angles than those according to Ackermann.

The approach presented here can be used, for example, in a parking garage to prevent or at least reduce squealing noises from a vehicle's tires. This makes other noises more perceptible and, for example, an engine noise from a vehicle driving straight ahead can be perceived that would otherwise have been drowned out.

A method for operating a steering mechanism of a vehicle is presented, wherein, in response to detecting a squealing situation, at least two steerable wheels of the vehicle are articulated according to Ackermann.

Ideas concerning embodiments of the disclosure may be regarded as being based, among other things, on the thoughts and findings described below.

A squealing situation can occur due to a combination of different factors. A little bit of grip on the floor or an underground with a low friction coefficient can be particularly characteristic of the squealing situation. Furthermore, the squealing situation can be caused by acoustics in the surroundings of the vehicle. Particularly in interior spaces, tire noise can be reflected back to the vehicle and be more noticeable to the passengers than in an open space without sound-reflecting walls. However, the squealing can also be caused by a low tire friction coefficient.

When a tire squeals, it indicates a high level of slippage. When squealing, the tire's tread blocks slide over the underground and are stimulated to squeal by the stick-slip effect.

A vehicle may have a steering kinematics that, in normal driving conditions, sets steering angles or steering locks that deviate from the Ackermann function. Particularly at large steering angles or a strong steering lock, a large slip can then occur on at least one wheel of an axle.

The vehicle may have a way to change the steering kinematics. Then the steering kinematics can be switched to steering angle according to Ackermann if there is a high potential for squealing tires when steering. This allows the wheels of the vehicle to roll around a common instantaneous center of rotation and minimizes slippage at all wheels.

One possibility for modifying the steering kinematics, for example, is to use individual wheel steering actuators on at least one axle of the vehicle. Individual wheel steering actuators can adjust the steering angle of the articulated wheels independently of each other. In the case of individual wheel steering actuators, the steering angle of the articulated wheel is set using a steering angle characteristic curve and a steering wheel angle. The steering angle characteristic curve describes a correlation or a translation of the steering wheel angle to the steering angle. The steering angle characteristic curve can be changed or exchanged in order to adjust the steering kinematics according to Ackermann.

The steering angles can be articulated according to Ackermann at more than two wheels of the vehicle when the vehicle is in a potential squealing situation.

At least one of the wheels can be articulated at maximum steering lock in a manner that deviates from Ackermann. At maximum steering lock of the steering wheel, the smallest possible curve radius can be requested. The curve radius can be reduced, for example, by positioning the steered wheels parallel to the steering according to Ackermann. At maximum steering lock, improved vehicle maneuverability may be more important than minimizing squealing. Alternatively or additionally, one of the wheels can hit a mechanical stop at the maximum steering lock and therefore cannot be turned any further. This also means that the steering angles cannot be adjusted according to Ackermann.

The steering kinematics of a vehicle axle that is articulated in a manner that deviates from Ackermann can be corrected using a further steered axle of the vehicle according to Ackermann. For example, a rear axle steering can be actuated so that all wheels roll around the common instantaneous center of rotation.

The wheels can be steered according to Ackermann if the vehicle is driving slower than a predefined speed value. The wheels can be articulated according to Ackermann to Ackermann at low speeds. Above the speed value, the advantages of the actuation may outweigh those of Ackermann. The speed value can, for example, be 30 km/h, 20 km/h, 10 km/h or 5 km/h.

A steering differential angle of individual wheel steering actuators of at least one axle of the vehicle can be adjusted according to Ackermann. Using individual wheel steering actuators, the approach presented here can be implemented particularly efficiently.

The squealing situation can be detected using at least one microphone of the vehicle. The microphone can, for example, be an external microphone and can detect external noise. The microphone can, for example, be arranged near the wheels. Alternatively or in addition, the microphone can be an interior microphone of the vehicle. The interior microphone can pick up noises coming from outside. The microphone can detect the squealing of the tires and the squealing situation can be recognized. When the tires squeal, the steering angle can be changed directly according to Ackermann.

The squealing situation can be detected when entering an interior space. In interior spaces, such as parking garages, a particularly large amount of sound can be reflected back to the vehicle, making the squealing sound particularly loud for passengers or passers-by. The steering angles can be adjusted to follow Ackermann when entering the interior space in order to reduce the probability of squealing.

The entry into the interior space can be detected by using a time and the ambient brightness. If the ambient brightness decreases abruptly during the day, the vehicle has probably just entered an interior space. If the ambient brightness increases abruptly at night, the vehicle has probably also just entered an interior space. The time and ambient brightness can be used to detect situations in which it should actually be light or dark, but is not. In this case, the vehicle has probably just entered an interior space.

Entry into the interior space may alternatively or additionally be detected using a navigation system of the vehicle. In the interior space, for example, a reception signal from navigation satellites suddenly deteriorates. Likewise, by using a position of the vehicle and a digital map, it can be detected whether the vehicle is on a road or in a building. The entry into a tunnel, for example, can also be detected based on the speed, since the speed of the vehicle is greater than 30 km/h, for example.

The entry can also be detected using a camera of the vehicle. Images and/or videos of the camera can be evaluated to detect the entry.

The method is preferably computer-implemented and can be implemented in software or hardware, for instance, or in a mixed form of software and hardware, for example in a driver assistance system.

The approach presented here also creates a control device, wherein the control device is configured to carry out, control or implement the steps of a variant of the method presented here in corresponding devices.

The control device can be an electrical device comprising at least one computing unit for processing signals or data, at least one memory unit for storing signals or data and at least one interface and/or communication interface for reading in or outputting data embedded in a communication protocol. The computing unit can, for instance, be a signal processor, a so-called system ASIC or a microcontroller for processing sensor signals and outputting data signals as a function of the sensor signals. The memory unit can be a flash memory, an EPROM or a magnetic memory unit, for example. The interface can be configured as a sensor interface for reading in the sensor signals from a sensor and/or as an actuator interface for outputting the data signals and/or control signals to an actuator. The communication interface can be configured to read in or output the data wirelessly and/or by wire. The interfaces can also be software modules that are provided on a microcontroller alongside other software modules, for example.

A computer program product or a computer program comprising program code that can be stored on a machine-readable carrier or storage medium, such as a semiconductor memory, a hard disk memory or an optical memory, and can be used to carry out, implement and/or control the steps of the method according to one of the above-described embodiments is advantageous as well, in particular when the program product or program is executed on a computer, in a control device or an apparatus.

It should be noted that some of the possible features and advantages of the disclosure are described here with reference to different embodiments. A person skilled in the art will recognize that the features of the control device and the method can be suitably combined, adapted, or interchanged to arrive at further embodiments of the disclosure.

### BRIEF DESCRIPTION OF THE DRAWING

Embodiments of the disclosure are described in the following with reference to the accompanying drawing, wherein neither the drawing nor the description are to be construed as limiting the disclosure.

The figure shows a flowchart of a method according to an exemplary embodiment.

The figure is merely schematic and not to scale. Identical reference numerals denote identical or functionally identical features.

### DETAILED DESCRIPTION

The figure shows a flowchart of a method according to an exemplary embodiment. Using the method, a steering mechanism 100 of a vehicle is actuated depending on the situation. In this case, wheels 102 of the vehicle are articulated to steering angles 104 according to Ackermann when a squealing situation 108 is detected 106. The articulation according to Ackermann causes the wheels 102 to roll around a common instantaneous center of rotation, resulting in only minimal slippage between the wheels 102 and the underground. Slip would lead to squealing of the tire treads of the 102 wheels on the underground, especially on surfaces with a low friction coefficient.

When the squealing situation 108 has ended, the wheels 102 are actuated again with steering angles 104 according to any vehicle-specific characteristic curve.

In an exemplary embodiments, the squealing situation 108 is detected when the vehicle is in an interior space 110. In this way, the interior space 110 can be detected, for example, via a GPS 112, a microphone 114, an environmental sensor system 116 and/or a light sensor system 118.

In an exemplary embodiment, a drive 120 of the vehicle is further actuated to reduce the power output when the squealing situation 108 is detected.

In an exemplary embodiment, individual steering angles 104 according to Ackermann are determined for individual wheel steering actuators 122 on at least one axle of the vehicle and actuated when the squealing situation 108 is detected. The steering angles 104 can be determined, for example, using a characteristic curve according to Ackermann.

Possible embodiments of the disclosure are summarized again below or presented with a slightly different choice of words.

A function for optimized operation of steering actuators to avoid tire noise is presented.

Modern vehicles are equipped with electromechanical steering connected to both wheels. The development of steering systems is moving more and more in the direction of by-wire systems that are mechanically decoupled from the driver, i.e. the classic mechanical connection between the driver and the wheels themselves is no longer necessary. In the case of the steering, the respective actuation takes place purely via one or more actuators. Central but also decentralized by-wire steering adjusters are already prior art for the rear axle. The first prototype vehicles with by-wire individual wheel steering actuators are known for the front axle.

Turning a tight radius at slow speeds, such as in a parking garage or on slick surfaces, often causes a squealing tire noise This is due to normal tire slippage on surfaces that are smoother than typical asphalt. Especially in an enclosed space such as an underground or multistory parking garage, this sound can reverberate and appear much louder, drowning out other ambient sounds.

With conventional steering systems, a high-pitched, unpleasant squealing noises can occur in interior spaces on floors with reduced traction, e.g. due to the application of special paints. This is caused by the tires, which typically do not roll ideally without slipping due to the steering kinematics, but instead generate lateral forces in the tire block, which, on these undergrounds with a low coefficient of friction u, cause the rubber blocks to slip and thus lead to an unpleasant squealing noises.

Here, an activation of the (single-wheel) steering actuators in interior spaces, such as parking garages, is presented that uses a characteristic curve/ratio as close as possible to or corresponding to the Ackermann ratio. The function presented here involves selecting a steering ratio depending on whether the vehicle is inside or outside.

The central aspect is an adjustment of the steering ratio by changing the characteristic for controlling the (single-wheel) steering actuators, so that they are set to near Ackermann when changing from outside to inside or when there are noticeable acoustic abnormalities, in order to enable an almost ideal rolling around the instantaneous center of rotation of the vehicle and thus to avoid squealing noises. Thus, a steering differential angle selection according to the location is presented to ensure an acoustically favorable behavior of the tires.

The driving situation can be recognized, for example, by means of a GPS signal or based on the environmental sensors. It is also possible to add a microphone (ideally in the outside area, e.g. in the wheel arch for moisture detection), but also the interior microphone.

As a rule, brightness sensors and clocks are installed in vehicles. Thus, entering a parking garage can be reliably detected.

In particular, with by-wire steering mechanisms, it is known how large the current steering power is. It can thus be very easily detected when the vehicle is traveling at low speed on relatively slippery ground. Here, a further distinction must be made as to whether it is a case of driving slowly in a parking garage or, for example, driving slowly around a curve on a slippery road with an equally low coefficient of friction, u.

The approach presented here can be used, for example, in a public parking garage, a workshop, a parking garage under private buildings, in garages, possibly also on driveways and, depending on the choice of surface, also in parking lots. The approach can also be used in situations such as manual or automated driving/parking with a driver in or outside the vehicle, e.g. when parking by remote control/key.

The approach presented here increases safety by enabling the perception of other sounds, e.g. vehicles without a steering mechanism or that produce less pronounced tire noise. Furthermore, it increases the comfort of the vehicle occupants and of persons within earshot of the vehicle by reducing or avoiding squealing noises in interior situations.

If there are single-wheel controllers on the rear axle, the steering differential angle selection can be selected accordingly on the right and left to unwind with as little slippage as possible.

The approach presented here can also be used with conventional steering systems when these are installed together with rear axle steering. In this case, the rear axle steering can be operated favorably with respect to tire noise in coordination with the front axle steering.

Rear axle steering improves the effect of the approach presented here. Normally, a front axle steering with a central controller uses a compromise and deviates from an ideal Ackermann steering, as this would only be a good choice in certain situations. The vehicle length can be virtually changed via the rear axle steering. Thus, the steering angles at the rear axle could be selected so that the front axle moves close to the Ackermann angle.

When using rear axle steering with single-wheel controller, an ideal solution for the entire vehicle can be achieved for the function presented. A multi-stage approach can be stored for this. At maximum steering wheel lock, the minimum turning circle is achieved. As soon as the steering wheel lock is reduced slightly, the additional leeway of the wheel steering angles is used to set the ideal angle distribution for minimum noise at this turning circle.

In addition to the steering kinematics, the drive can also lead to the described noise generation. Cross slip at the tires of the steered axle is generated here when the vehicle speed is too high due to the drive torques requested by the driver and thus does not match the steering angle of the wheels (Ackermann/rolling condition). Therefore, the drive can be taken into account in the presented function. In this case, the drive torques requested by the driver are reduced for small curve radii so that the speed required to maintain the rolling condition is not exceeded. The drive is only taken into account on a level road or in situations in which this does not lead to any change in vehicle behavior with regard to acceleration, etc.

Lastly, it should be noted that terms such as “comprising”, “including”, etc. do not exclude other elements or steps and terms such as “one” or “a” do not exclude a plurality. Reference numerals in the claims should not be construed as limitations.

What is claimed is:

1. A method for operating a steering mechanism of a vehicle, comprising:
in response to detecting a squealing situation, articulating at least two steerable wheels of the vehicle according to Ackermann.

2. The method according to claim 1, wherein at least one of the at least two steerable wheels is articulated at a maximum steering lock in a manner that deviates from Ackermann.

3. The method according to claim 1, further comprising:
correcting a steering kinematics of an axle of the vehicle that is articulated in a manner that deviates from Ackermann using a further steered axle of the vehicle according to Ackermann.

4. The method according to claim 1, wherein the at least two steerable wheels are steered according to Ackermann when the vehicle is traveling slower than a predefined speed value.

5. The method according to claim 1, further comprising:
adjusting a steering differential angle of individual wheel steering actuators of at least one axle of the vehicle according to Ackermann.

6. The method according to claim 1, further comprising:
detecting the squealing situation using at least one microphone of the vehicle.

7. The method according to claim 1, further comprising:
detecting the squealing situation when entering an interior space.

8. The method according to claim 7, further comprising:
detecting entry into the interior space using a time and an ambient brightness.

9. The method according to claim 7, further comprising:
detecting entry into the interior space using a navigation system of the vehicle.

10. The method according to claim 1, wherein a computer program product is configured to direct a processor to execute, implement, and/or control the method when the computer program product is executed.

11. A non-transitory machine-readable storage medium on which the computer program product according to claim 10 is stored.

12. A control device, wherein the control device is configured to execute, implement and/or control the method according to claim 1.
